(19) United States
(12) Patent Application Publication
(10) Pub. No.: US 2020/0232940 A1
(43) Pub. Date: Jul. 23, 2020

(54) ELECTRODE SUPPORT AND ELECTRODE ASSEMBLY

(71) Applicant: University of Chester, Chester Cheshire (GB)

(72) Inventors: Trevor James Davies, Chester Chesire (GB); Robert Edward Smith, Chester Chesire (GB)

(21) Appl. No.: 16/633,091

(22) PCT Filed: Jul. 23, 2018
(86) PCT No.: PCT/GB2018/052068

§ 371 Date: Jan. 22, 2020

(30) Foreign Application Priority Data
Jul. 24, 2017 (GB) 1711864.7

(51) Int. Cl. G01N 27/30

(52) U.S. Cl. CPC G01N 27/308

(57) ABSTRACT

An electrode assembly (10) for electroanalysis, the electrode assembly (10) comprising a woven or non-woven carbon fibre electrode (20) supported by a support (100), wherein the support (100) comprises an electrical conductor (110) having a region (120) comprising carbon and wherein the region (120) is arranged to electrically couple with the woven or non-woven carbon fibre electrode (20).

### FIELD

The present invention relates to a support for a carbon fibre electrode for electroanalysis and an electrode assembly comprising a carbon fibre electrode and such a support.

### BACKGROUND TO THE INVENTION

Generally, electroanalysis techniques, for example potentiometry, coulometry and voltammetry, provide determination of analyte concentrations, for example, by measuring potentials across and/or currents in electrochemical cells containing the analytes. In voltammetry, typically a constant and/or varying potential is applied to an electrode (also known as a sensor) immersed in a solution comprising the analytes and a resulting current is measured with a three electrode system.

Anodic stripping voltammetry (ASV), a subset of stripping voltammetry (SV), is a low-cost method of voltammetry for quantitative determination of specific ionic analytes. ASV may be applied to a large range of metal analytes and organic/organometallic molecular analytes, at concentrations less than ppb for some analytes. Generally, ASV involves a pre-concentration step, in which an analyte of interest is deposited on a surface of a working electrode, followed by a stripping step, in which the deposited analyte deposit dissolves back into solution due to an electrode potential ramp. The stripping step generates an electrochemical signal from which the analyte may be identified and quantified. Typically in ASV, the analyte is a metal cation that, in the pre-concentration step, undergoes reduction forming a neutral metal deposit on the surface of the working electrode. The electrode potential is then increased until the metal deposit undergoes oxidation back to the (aqueous) cation, essentially being stripped from the surface.

Improving a limit of detection of electroanalysis is important to enable detection and/or quantification of analytes at lower concentrations, for example. For electrochemical sensors such as working electrodes, a conventional method of improving the limit of detection is by increasing current densities, thereby increasing signal to noise (S/N) ratios. For example, in quiescent solutions, increasing current densities may be achieved by using micro or nano-sized electrodes, since decreasing electrode sizes increases mass transport coefficients. However, as the electrode sizes decrease, fabrication complexity and/or cost increase. In addition, while the current densities may increase, the currents decrease in magnitude, thereby requiring higher specification potentiostats and/or low-noise environments.

Another approach to improving limits of detection in stripping voltammetry is to increase the magnitude of the stripping signal relative to the baseline by dramatically increasing the amount of material deposited in the pre-concentration step. This is best achieved via incorporating solution flow into the electrochemical system.

Mercury electrodes (or mercury film modified electrodes) are often used in ASV experiments as they provide excellent signal to noise ratios. In the pre-concentration step, the mercury electrode forms an amalgam with the analyte of interest, which upon oxidation results in a sharp stripping signal, However, mercury is a toxic material and as such, mercury electrodes are often undesirable tools in electroanalysis.

Hence, there is a need to improve electroanalysis, for example by improving limits of detection.

### SUMMARY OF THE INVENTION

It is one aim of the present invention, amongst others, to provide a support for a woven or non-woven carbon fibre electrode for electroanalysis and an electrode assembly comprising a woven or non-woven carbon fibre electrode and such a support which at least partially obviates or mitigates at least some of the disadvantages of the prior art, whether identified herein or elsewhere. For instance, it is an aim of embodiments of the invention to provide a support for porous carbon electrode, such as a woven or non-woven carbon fibre electrode, that improves limits of detection of electroanalysis.

According to a first aspect, there is provided an electrode assembly for electroanalysis, the electrode assembly comprising a woven or non-woven carbon fibre electrode supported by a support, wherein the support comprises an electrical conductor having a region comprising carbon and wherein the region is arranged to electrically couple with the woven or non-woven carbon fibre electrode.

According to a second aspect, there is provided a support for a porous carbon electrode for electroanalysis, wherein the support comprises an electrical conductor, wherein the electrical conductor comprises a first metal, wherein the electrical conductor has a coating layer comprising carbon and wherein the coating layer is arranged to, in use, electrically couple with the porous carbon electrode.

According to a third aspect, there is provided an electrode assembly for electroanalysis, the electrode assembly comprising a porous carbon electrode supported by the support according to the second aspect and wherein the coating layer is arranged to electrically couple with the porous carbon electrode.

According to a fourth aspect, there is provided a flow cell comprising an electrode assembly according to the first aspect or the third aspect.

According to a fifth aspect, there is provided a method of manufacturing a support for an electroanalysis porous carbon electrode, the method comprising:
coating an electrical conductor comprising a first metal with a coating layer comprising carbon;
   wherein the coating layer is arranged to, in use, electrically couple with the porous carbon electrode.

According to a sixth aspect, there is provided use of an electrical conductor comprising a first metal, wherein the electrical conductor has a coating layer comprising carbon, as a support for a porous carbon electrode for electroanalysis, wherein the coating layer is arranged to, in use, electrically couple with the porous carbon electrode.

According to a seventh aspect, there is provided use of an electrode assembly according to the first aspect or the third aspect or of a flow cell according to the fourth aspect for electroanalysis of metal cations.

According to the eighth aspect, there is provided use of an electrode assembly according to the first aspect or the third aspect or of a flow cell according to the fourth aspect for electroanalysis of analytes of interest.

### DETAILED DESCRIPTION OF THE INVENTION

According to the present invention there is provided an electrode assembly, as set forth in the appended claims. Also provided is a support for an electrode, a flow cell, a method manufacturing a support, use of an electrode assembly and use of a flow cell. Other features of the invention will be apparent from the dependent claims, and the description that follows.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

According to the first aspect, there is provided an electrode assembly for electroanalysis, the electrode assembly comprising a woven or non-woven carbon fibre electrode supported by a support, wherein the support comprises an electrical conductor having a region comprising carbon and wherein the region is arranged to electrically couple with the woven or non-woven carbon fibre electrode.

In this way, a limit of detection of electroanalysis may be improved, compared with conventional electrode assemblies. Particularly, by electrically coupling the woven or non-woven carbon fibre electrode (i.e. a working electrode) to the region comprising carbon of the electrical conductor of the support, a background current (also known as a baseline) due to the support may be reduced, thereby improving the limit of detection.

It should be understood that the support acts as a terminal for the electrical connection to the porous carbon electrode. For example, a part of the support outside of the porous electrode and outside of an analyte solution, in use, acts as the terminal for the electrical connection to the porous electrode.

It should be understood that the woven or non-woven carbon fibre electrode, in use, is immersed in a solution comprising an analyte of interest. For example, the woven or non-woven carbon fibre electrode may provide a working electrode for ASV, as described previously. It should be understood that the support is arranged to structurally support, and/or provide additional structural support for, the woven or non-woven carbon fibre electrode. It should be understood that the support is arranged to, in use, electrically couple the woven or non-woven carbon fibre electrode to an electrical circuit of an electroanalysis apparatus for the electroanalysis. In use, at least a part of the support may be immersed in the solution. The inventors have determined that the support, for example the part of the support immersed in the solution and/or the electrical coupling between the support and the woven or non-woven carbon fibre electrode, may affect, for example adversely affect or limit, the limits of detection of the electroanalysis. By providing the electrode assembly comprising the woven or non-woven carbon fibre electrode supported by the support, the limits of detection of the electroanalysis may be improved compared, for example, with such electrodes supported by conventional supports.

Generally, woven carbon fibre electrodes may be described as sheet structures formed by weaving carbon fibres. Generally, non-woven carbon fibre electrodes may be described as sheet or web structures bonded together by entangling carbon fibres or filaments mechanically, thermally or chemically. Examples of woven or non-woven carbon fibre electrodes include graphite felt (GF) electrodes, woven carbon fibre cloth electrodes, non-woven carbon fibre cloth electrodes, carbon fibre veil electrodes, chopped carbon fibre electrodes and carbon fibre paper electrodes. In one example, the woven or non-woven carbon fibre electrode is a GF electrode. GF electrodes generally have higher porosities compared with other woven or non-woven carbon fibre electrodes, thereby allowing easier access of liquid analytes to the internal surfaces of the material.

The support comprises the electrical conductor having the region comprising carbon and wherein the region is arranged to electrically couple with the woven or non-woven carbon fibre electrode. It should be understood that the region is arranged to electrically couple with at least part of the woven or non-woven carbon fibre electrode. That is, since the woven or non-woven carbon fibre electrode is electrically conductive, by electrically coupling with at least part of the woven or non-woven carbon fibre electrode, the region in turn electrically couples with the whole woven or non-woven carbon fibre electrode.

The region comprising the carbon may be a surface region of the electrical conductor, for example an exposed surface region of the electrical conductor. In this way, the region may be arranged to electrically couple with the woven or non-woven carbon fibre electrode by contacting, for example physically contacting, with the woven or non-woven carbon fibre electrode and/or a part thereof. For example, the electrical conductor may be formed from carbon, for example a graphite rod. For example, the electrical conductor may have a coating layer comprising the carbon. The coating layer may be an outer coating layer, for example, as described below with respect to the second aspect.

The support may be arranged as a frame for the woven or non-woven carbon fibre electrode and thereby structurally support the woven or non-woven carbon fibre electrode. The woven or non-woven carbon fibre electrode may be retained on the support frictionally and/or by clamping, for example. The support may comprise a retaining member, arranged to retain the woven or non-woven carbon fibre electrode thereon. For example, the retaining member may comprise an adhesive such as a cured epoxy or cured conductive epoxy. Generally, the retaining member comprises a material selected to be electrochemically inert in the potential window of interest, as described below. In one example, the retaining member is arranged to isolate, for example by covering, an uncoated region of the electrical conductor, thereby reducing occurrence of hydrogen gas generation therefrom, in use. For example, where the support is provided by cutting a length of a coated wire, an amount of epoxy may be deposited over a cut end thereof. Otherwise the cut end is uncoated and hence the first metal would then be exposed to the solution, in use.

In one example, the electrical conductor comprises a first metal, as described below with respect to the second aspect.

Other features of the support may be as described with respect to the second aspect.

According to the second aspect, there is provided a support for a porous carbon electrode for electroanalysis, wherein the support comprises an electrical conductor, wherein the electrical conductor comprises a first metal, wherein the electrical conductor has a coating layer comprising carbon and wherein the coating layer is arranged to, in use, electrically couple with the porous carbon electrode.

In this way, a limit of detection of electroanalysis may be improved, compared with conventional electrode assemblies. Particularly, by electrically coupling the porous carbon electrode to the coating layer comprising carbon of the electrical conductor of the support, a background current (also known as a baseline) due to the support may be reduced, thereby improving the limit of detection.

It should be understood that the porous carbon electrode, in use, is immersed in a solution comprising an analyte of interest. For example, the porous carbon electrode may provide a working electrode for ASV, as described previously. It should be understood that the support is arranged to structurally support, and/or provide additional structural support for, the porous carbon electrode. It should be understood that the support is arranged to, in use, electrically couple the porous carbon electrode to an electrical circuit of an electroanalysis apparatus for the electroanalysis. In use, at least a part of the support may be immersed in the solution. The inventors have determined that the support, for example the part of the support immersed in the solution and/or the electrical coupling between the support and the porous carbon electrode, may affect, for example adversely affect or limit, the limits of detection of the electroanalysis. By providing the electrode assembly comprising the porous carbon electrode supported by the support, the limits of detection of the electroanalysis may be improved compared, for example, with such electrodes supported by conventional supports.

It should be understood that the coating layer is electrically conductive. It should be understood that the coating layer comprising carbon of the electrical conductor is an outer coating of the electrical conductor thereby, for example, providing an exposed surface region. In this way, the coating layer may be arranged to electrically couple with the porous carbon electrode by contacting, for example physically contacting, with the porous carbon electrode and/or a part thereof.

Examples of porous carbon electrodes include glassy carbon foam (or reticulated vitreous carbon), carbon aerogels, carbon powders and woven or non-woven carbon fibre electrodes. Examples of woven or non-woven carbon fibre electrodes include graphite felt (GF) electrodes, woven carbon fibre cloth electrodes, non-woven carbon fibre cloth electrodes, non-woven carbon fibre gas diffusion layers, carbon fibre veil electrodes, chopped carbon fibre electrodes and carbon fibre paper electrodes. In one example, the porous carbon electrode is a woven or non-woven carbon fibre electrode. In one example, the woven or non-woven carbon fibre electrode is a GF electrode. GF electrodes generally have higher porosities compared with other woven or non-woven carbon fibre electrodes, thereby allowing easier access of liquid analytes to the internal surfaces of the material. In one example, the porous carbon electrode comprises carbon fibers, carbon tubes, carbon microtubes, carbon microspheres, nano-sized carbon fibers, nano-sized carbon tubes, carbon sheets, graphene and/or combinations thereof. Carbon microspheres may include nano-sized Buckyball supports, having a diameter less than 200 nm and/or comminuted and/or graded microspheres formed by grinding and/or milling carbon, such as Vulcan 52. Carbon sheets include carbon paper, such as that made by Toray™, having a thickness of 200 nanometers or less, and may be continuous, perforated, or partially perforated, wherein the perforations have diameters ranging from 1 to 50 nm. Carbon tubes typical have a diameter ranging from 100 to 200 nanometers and a length ranging from 3,000 to 100,000 nanometers, for example nano-CAPP or nano-CPT and/or carbon tubes made by Pyrograf®. Graphene includes pristine monolayers of graphite, multilayers (for example 2 to 5 layers) of graphite, flakes thereof, graphene formed by reduction of graphene oxide and may be continuous or perforated.

The electrical conductor comprises the first metal, for example an unalloyed metal or an alloy. It should be understood that unalloyed metals refer to metals having relatively high purities, for example at least 95 wt. %, at least 97 wt. %, at least 99 wt. %, at least 99.5 wt. %, at least 99.9 wt. %, at least 99.95 wt. %, at least 99.99 wt. %, at least 99.995 wt. % or at least 99.999 wt. % purity. These unalloyed metals may contain no deliberate alloying additions and/or may contain only unavoidable impurities. In contrast, alloys include deliberate alloying additions. Generally, suitable metals may be electrochemically inert in a potential window of interest, meaning that the metals do not take part in any redox reactions, in use. That is, suitable metals do not undergo heterogeneous electron transfer reactions with solution phase redox species, in use, and do not react with the solution. In other words, dissolution of the first metal does not occur, in use. Additionally and/or alternatively, suitable metals may be noble, meaning that the metals may undergo heterogeneous electron transfer reactions, acting as electron sources or sinks, but are not consumed, in use. Examples of suitable unalloyed metals include first, second and third row transition metals. For example, titanium, chromium, nickel, zinc, copper and silver gold may be electrochemically inert in the potential window of interest. For example, platinum and gold are often considered as noble metals in electrochemistry. Examples of suitable alloys include steels, for example stainless steels. Stainless steels are available in various grades, for example 200 Series, 300 Series and 400 Series. Example 300 Series stainless steels include Types 301, 302, 302B, 303, 303Se, 304, 304L, 304Cu, 304N, 305, 308, 309, 309S, 310, 310S, 314, 316, 316L, 316F, 316N, 317, 317L, 321, 329, 330, 347, 348 and 384. Types 304, 304L, 316 and 316L are preferred. In one example, the first metal is selected from a group consisting of titanium, chromium, nickel, zinc, copper, silver, gold, platinum and stainless steel.

The support may be provided as a wire, for example, formed from the first metal, as described above. Metallic wires are generally electrical conductors and may provide structural support for the woven or non-woven carbon fibre electrode. Metallic wires are generally readily available, formed from various metals or alloys such as the first metal, and of various diameters (also known as gauges). In one example, the support comprises a wire formed from a first metal, the wire having a region comprising carbon, wherein the wire provides the electrical conductor, and wherein the region is arranged to electrically couple with the porous carbon electrode, for example a woven or non-woven carbon fibre electrode.

Generally, a size of the support, for example an immersed size of the support in use, may be optimised to provide sufficient structural support and/or to reliably electrically couple with the porous carbon electrode, while reducing also background currents that may affect limits of detection. The immersed size of the support in use may relate to an immersed surface area in use, a diameter of the support, and/or an immersed length of the support in use, for example. The size of the support may depend, at least in part, on a size of the supported porous carbon electrode. For example, the porous carbon electrode may have a size of 1 cm×1 cm. Other sizes of the porous carbon electrode are possible. For the examples of the invention described below, the porous carbon electrode may have a size of 1 cm×10 cm.

In one example, the support has an immersed surface area, in use, in a range of from 0.0075 to 15 mm², preferably in a range of from 0.05 to 10 mm², more preferably in a range of from 0.5 to 5 mm², for example 2 mm². Supports having relatively larger immersed surface areas, may result in increased background currents. Conversely, supports having relatively smaller immersed surface areas may not provide sufficient structural support and/or not reliably electrically couple with the porous carbon electrode. The immersed surface area in use may be an immersed exposed surface area in use.

In one example, the support has a diameter in a range of from 0.1 to 1.0 mm, preferably in a range of from 0.25 to 0.75 mm, more preferably in a range of from 0.4 to 0.6 mm, for example 0.5 mm. Supports having relatively larger diameters, for example at least 1.0 mm, at least 0.75 mm or at least 0.6 mm, may result in increased background currents. Conversely, supports having relatively smaller diameters, for example at most 0.1 mm, at most 0.25 mm or at most 0.4 mm, may not provide sufficient structural support and/or not reliably electrically couple with the porous carbon electrode.

In one example, the support is provided as a wire and the wire has a diameter in a range of from 0.1 to 1.0 mm, preferably in a range of from 0.25 to 0.75 mm, more preferably in a range of from 0.4 to 0.6 mm, for example 0.5 mm. Wires having relatively larger diameters, for example at least 1.0 mm, at least 0.75 mm or at least 0.6 mm, may result in increased background currents. Conversely, wires having relatively smaller diameters, for example at most 0.1 mm, at most 0.25 mm or at most 0.4 mm, may not provide sufficient structural support and/or not reliably electrically couple with the porous carbon electrode.

Generally, the support has a length larger than that of the porous carbon electrode. In one example, the support is arranged to extend through (i.e. protrude through) the porous carbon electrode. In this way, any hydrogen gas generated, for example, from the support in use tends to move, for example rise as bubbles, away from the porous carbon electrode, thereby reducing surface blocking of the porous carbon electrode by the hydrogen gas and hence maintaining performance of the porous carbon electrode.

In one example, the support has an immersed length in a range of from 1 to 100 mm, preferably in a range of from 5 to 75 mm, more preferably in a range of from 10 to 50 mm, for example 25 mm. Supports having relatively longer immersed lengths may result in increased background currents. Conversely, supports having relatively smaller immersed lengths may not provide sufficient structural support and/or not reliably electrically couple with the porous carbon electrode.

In one example, the support is provided as a wire and the wire has an immersed length in a range of from 1 to 100 mm, preferably in a range of from 5 to 75 mm, more preferably in a range of from 10 to 50 mm, for example 25 mm. Wires having relatively longer immersed lengths, may result in increased background currents. Conversely, wires having relatively smaller immersed lengths, may not provide sufficient structural support and/or not reliably electrically couple with the porous carbon electrode.

In one example, the support comprises a first interlayer arranged between the electrical conductor and the coating layer. The first interlayer may, for example, provide a suitable surface upon or above which other layers, such as the coating layer, may be provided. The first interlayer may, for example, improve compatibility, adhesion and/or coherency with or of the coating layer to the electrical conductor. It should be understood that the first interlayer is electrically conductive.

In one example, the first interlayer is adjacent to the electrical conductor. For example, the first interlayer may be arranged directly on the electrical conductor. For example, the first interlayer may be provided, such as deposited, printed, sprayed, plated and/or sputtered, directly on the electrical conductor. In one example, the first interlayer comprises a second metal. In one example, the first interlayer consists of a second metal. The second metal may be as described with respect to the first metal. For example, the second metal may be an unalloyed metal, as described with respect to the first metal. In one example, the second metal is a transition metal, for example, a first, second or third row transition metal, preferably a first row transition metal. In one example, the second metal is selected from a group consisting of titanium, chromium, nickel and zinc. Preferably, the second metal is titanium or chromium. More preferably, the second metal is titanium. Titanium may result in lower background currents than chromium, thereby improving limits of detection.

In one example, the first interlayer has a thickness of at least 0.001 μm, at least 0.01 μm or at least 0.1 μm. In one example, the first interlayer has a thickness of at most 0.01 μm, at most 0.1 μm, at most 1 μm or at most 10 μm.

In one example, the support comprises a second interlayer arranged between the electrical conductor and the coating layer. The second interlayer may, for example, provide a suitable surface upon or above which other layers, such as the coating layer, may be provided. The second interlayer may, for example, improve compatibility, adhesion and/or coherency with or of the coating layer to the electrical conductor. It should be understood that the second interlayer is electrically conductive.

In one example, the second interlayer is adjacent to the coating layer. For example, the second interlayer may be arranged directly on the first interlayer. For example, the second interlayer may be provided, such as deposited, printed, sprayed, plated and/or sputtered, directly on the first interlayer. In one example, the second interlayer comprises carbon and a third metal. The third metal may be as described with respect to the second metal. For example, the third metal may be an unalloyed metal, as described with respect to the second metal. In one example, the third metal is a transition metal, for example, a first, second or third row transition metal, preferably a first row transition metal. In one example, the third metal is selected from a group consisting of titanium, chromium, nickel and zinc. Titanium and chromium are preferred.

In one example, the second interlayer comprises carbon and a third metal, wherein a composition of the second interlayer is provided as a gradient composition. For example, the composition of the interlayer proximal the coating layer may have a relatively higher carbon content while the composition of the interlayer distal the coating layer may have a relatively lower carbon content. Conversely, for example, the composition of the interlayer proximal the coating layer may have a relatively lower third metal content while the composition of the interlayer distal the coating layer may have a relatively higher third metal content. That is, the composition of the second interlayer may become richer in carbon towards the coating layer. In this way, compatibility, adhesion and/or coherency, for example, with or of the coating layer to the electrical conductor may be improved.

In one example, the second interlayer has a thickness of at least 0.001 μm, at least 0.01 μm or at least 0.1 μm. In one example, the second interlayer has a thickness of at most 0.01 μm, at most 0.1 μm, at most 1 μm or at most 10 μm.

In one example, the coating layer comprises a non-porous coating layer, for example an impermeable coating layer. In this way, retention of solution, analytes and/or gas such as air by the coating layer, for example, may be reduced, thereby improving background currents. Generally, the coating layer should be fully dense, having no pores and/or perforations therethrough. The first interlayer and/or the second interlayer may similarly be non-porous and/or fully dense.

In one example, the coating layer comprises at least 50 wt. %, at least 60 wt. %, at least 70 wt. %, at least 80 wt. %, at least 90 wt. %, at least 95 wt. %, at least 98 wt. %, at least 99 wt. %, at least 99.5 wt. %, at least 99.9 wt. %, at least 99.95 wt. % or at least 99.99 wt. % carbon, by weight of the coating layer. In one example, the coating layer comprises essentially pure carbon.

In one example, the carbon comprising the coating layer is graphite, for example amorphous, partially crystalline, crystalline and/or microcrystalline graphite. Microcrystalline graphite is preferred.

In one example, the coating layer has a thickness of at least 0.01 μm, at least 0.1 μm or at least 1 μm. In one example, the coating layer has a thickness of at most 0.1 μm, at most 1 μm or at most 10 μm.

In one example, the coating layer is provided over at least 50%, at least 60%, at least 70%, at least 80%, at least 90%, at least 95%, at least 98%, at least 99%, at least 99.5%, at least 99.9%, at least 99.95% or at least 99.99% of a surface of the electrical conductor. In one example, the coating layer is provided over at most 60%, at most 70%, at most 80%, at most 90%, at most 95%, at most 98%, at most 99%, at most 99.5%, at most 99.9%, at most 99.95% or at most 99.99% of a surface of the electrical conductor. It should be understood that the surface of the electrical conductor is the immersed surface of the electrical conductor, in use. For example, if the electrical conductor is provided as a wire having the coating layer, cylindrical surfaces of the wire may be coated while an end of the wire may be uncoated.

According to the third aspect, there is provided an electrode assembly for electroanalysis, the electrode assembly comprising a porous carbon electrode supported by the support according to the second aspect and wherein the coating layer is arranged to electrically couple with the porous carbon electrode.

According to the fourth aspect, there is provided a flow cell comprising an electrode assembly according to the first aspect or the third aspect.

The electrode assembly may provide a working electrode. The flow cell may comprise a chamber arranged to receive the electrode assembly. The flow cell may comprise a second electrode assembly according to the first aspect or the third aspect. The second electrode assembly may provide a counter electrode. The flow cell may comprise a second chamber arranged to receive the second electrode assembly. The flow cell may comprise a channel arranged between the first chamber and the second chamber, for flow of a liquid therebetween. The flow cell may comprise a conduit extending from the chamber and arranged through a wall of the flow cell to receive the support of the electrode assembly. The flow cell may comprise a second conduit extending from the second chamber and arranged through the wall of the flow cell to receive the support of the second electrode assembly. The flow cell may comprise a first section and a second section, wherein the first section is releasably coupled to the second section. A first part of the chamber and/or a first part of the second chamber may be arranged in the first section. A second part of the chamber and/or a second part of the second chamber may be arranged in the second section. The flow cell may comprise a sealing member, for example a gasket, arranged between the first section and the second section.

According to the fifth aspect, there is provided a method of manufacturing a support for an electroanalysis porous carbon electrode, the method comprising:
coating an electrical conductor comprising a first metal with a coating layer comprising carbon;
   wherein the coating layer is arranged to, in use, electrically couple with the porous carbon electrode.

The electrical conductor, the first metal, the coating layer and/or the porous carbon electrode may be as described with respect to the first aspect and/or the second aspect.

The step of coating the electrical conductor with the coating layer may comprise depositing, printing, spraying, plating and/or sputtering carbon.

In one example, the method comprises providing a first interlayer on the electrical conductor and wherein the first interlayer comprises a second metal.

The step of providing the first interlayer may comprise depositing, printing, spraying, plating and/or sputtering the second metal on the electrical conductor.

The first interlayer and/or the second metal may be as described with respect to the second aspect.

In one example, the method comprises providing a second interlayer on the first interlayer, wherein the second interlayer comprises carbon and a third metal and wherein the coating layer is provided on the second interlayer.

The second interlayer and/or the third metal may be as described with respect to the second aspect.

The step of providing the second interlayer may comprise depositing, printing, spraying, plating and/or sputtering the third metal and/or the carbon on the electrical conductor.

The method of manufacturing the support may comprise a step of cleaning the electrical conductor prior to the step of coating.

The method of manufacturing the support may comprise a step of dividing the coated electrical conductor into a plurality of supports. For example, if the electrical conductor is provided as a length of wire, the coated electrical conductor may be cut after coating, thereby providing a plurality of supports. In this way, fabrication cost and/or complexity may be reduced.

According to the sixth aspect, there is provided use of an electrical conductor comprising a first metal, wherein the electrical conductor has a coating layer comprising carbon, as a support for a porous carbon electrode for electroanalysis, wherein the coating layer is arranged to, in use, electrically couple with the porous carbon electrode.

According to the seventh aspect, there is provided use of an electrode assembly according to the first aspect or the third aspect or of a flow cell according to the fourth aspect for electroanalysis of metal cations.

Examples of metal cations include cations of first, second and third row transition metals, for example cations of heavy metals. For example, metal cations include cations of such as lead, cadmium, mercury, copper, zinc, nickel, cobalt, uranium, iron, antinomy, tin, silver, manganese, chromium, tungsten, molybdenum, selenium, europium and arsenic.

According to the eighth aspect, there is provided use of an electrode assembly according to the first aspect or the third aspect or of a flow cell according to the fourth aspect for electroanalysis of analytes of interest.

Examples of analytes of interest include biomolecules, vitamins, toxins and drugs such as uric acid, ascorbic acid, cannabinoids, cathinones and many others.

In one example, the electroanalysis is anodic stripping voltammetry (ASV).

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a longitudinal cross section of an electrode assembly according to an exemplary embodiment of the invention;

FIG. 2 schematically depicts a longitudinal cross section of a support for an electrode according to an exemplary embodiment of the invention;

FIG. 3A schematically depicts a longitudinal cross section of another support for an electrode according to an exemplary embodiment of the invention and FIG. 3B schematically depicts a longitudinal cross section of the support of FIG. 3A in more detail;

FIG. 4A schematically depicts a longitudinal cross section of yet another support for an electrode according to an exemplary embodiment of the invention and FIG. 4B schematically depicts a longitudinal cross section of the support of FIG. 4A in more detail;

FIG. 5A schematically depicts a longitudinal cross section of still yet another support for an electrode according to an exemplary embodiment of the invention and FIG. 5B schematically depicts a longitudinal cross section of the support of FIG. 5A in more detail;

FIGS. 6A-6D schematically depict a flow cell according to an exemplary embodiment of the invention;

FIG. 7 schematically depicts results of anodic stripping voltammetry obtained with edge plane pyrolytic graphite (EPPG), basal plane pyrolytic graphite (BPPG) and pyrolytic formed carbon (PFC) disc electrodes (3 mm diameter) in 0.25 μM Pb(NO₃)₂/0.1 M NaBF4 at 50 mV s⁻¹;

FIG. 8 schematically depicts results of anodic stripping voltammetry obtained with GF-carbon coated stainless steel wire, GF-carbon rod and GF-metal wire electrodes in 0.25 μM Pb(NO₃)₂/0.1 M NaBF₄ at 50 mV s⁻¹;

FIG. 9 schematically depicts results of anodic stripping voltammetry obtained with GF-carbon coated stainless steel wire and GF-titanium wire electrodes in 0.25 μM Pb(NO₃)₂/0.1 M NaBF₄ at 50 mV S⁻¹;

FIG. 10 schematically depicts results of anodic stripping voltammetry obtained with a GF-carbon coated stainless steel wire electrode and a carbon coated stainless steel wire in 0.25 μM Pb(NO₃)₂/0.1 M NaBF₄ at 50 mV s⁻¹;

FIGS. 11A and 11B schematically depict results of anodic stripping voltammetry obtained with GF-carbon coated stainless steel wire electrode in 0.16 μM Pb(NO₃)₂/0.1 M NaBF₄ and 25 nM Pb(NO₃)₂/0.1 M NaBF₄ at 50 mV s⁻¹, respectively. In both plots, the fitted baseline is overlaid;

FIG. 12 schematically depicts results of anodic stripping voltammetry showing a plot of stripping charge versus Pb²⁺ concentration for ASV experiments with GF-carbon coated stainless steel wire electrodes in solutions of increasing concentrations of Pb(NO₃)₂;

FIG. 13 schematically depicts results of anodic stripping voltammetry obtained with EPPG, BPPG and PFC disc electrodes (3 mm diameter) in 0.5 μM CdSO₄/0.1 M NaBF₄ at 50 mV s⁻¹;

FIG. 14 schematically depicts results of anodic stripping voltammetry obtained with GF-carbon coated stainless steel wire, GF-carbon rod and GF-metal wire electrodes in 0.5 μM CdSO₄/0.1 M NaBF₄ at 50 mV s⁻¹;

FIG. 15 schematically depicts results of anodic stripping voltammetry obtained with GF-carbon coated stainless steel wire, GF-gold wire and GF-copper wire electrodes in 0.5 μM CdSO₄/0.1 M NaBF₄ at 50 mV s⁻¹;

FIG. 16 schematically depicts results of anodic stripping voltammetry GF-carbon coated stainless steel wire electrode in 0.16 μM CdSO₄/0.1 M NaBF₄ at 50 mV s⁻¹. The fitted baseline is overlaid;

FIG. 17 schematically depicts results of anodic stripping voltammetry showing a plot of stripping charge versus Cd²⁺ concentration for ASV experiments with GF-carbon coated stainless steel wire electrodes in solutions of increasing concentrations of CdSO₄;

FIG. 18 schematically depicts results of anodic stripping voltammetry obtained with a flow cell using Pt and carbon coated stainless steel wire connections to a GF electrode in 0.5 μM CdSO₄/0.1 M NaBF₄ at 50 mV s⁻¹;

FIG. 19 schematically depicts results of anodic stripping voltammetry obtained with a flow cell using a carbon coated stainless steel wire connection to a GF electrode in 0.5 μM CdSO₄/0.1 M NaBF₄ at 50 mV s⁻¹; and

FIG. 20 schematically depicts a method of manufacturing an according to an exemplary embodiment of the invention.

### DETAILED DESCRIPTION OF THE DRAWINGS

Generally, like reference signs denote like features, description of which is not repeated for brevity.

FIG. 1 schematically depicts a longitudinal cross section of an electrode assembly 10 according to an exemplary embodiment of the invention.

In detail, the electrode assembly 10 is for electroanalysis. The electrode assembly 10 comprises a woven or non-woven carbon fibre electrode 20 supported by a support 100, wherein the support 100 comprises an electrical conductor 110 having a region 120 comprising carbon and wherein the region 120 is arranged to electrically couple with the woven or non-woven carbon fibre electrode 20. In this way, a limit of detection of the electroanalysis may be improved, as described previously.

In this example, the electrical conductor 110 is a metal wire, having a diameter of 0.5 mm and a length larger than that of the carbon fibre electrode. In this example, the electrode 20 is a GF electrode.

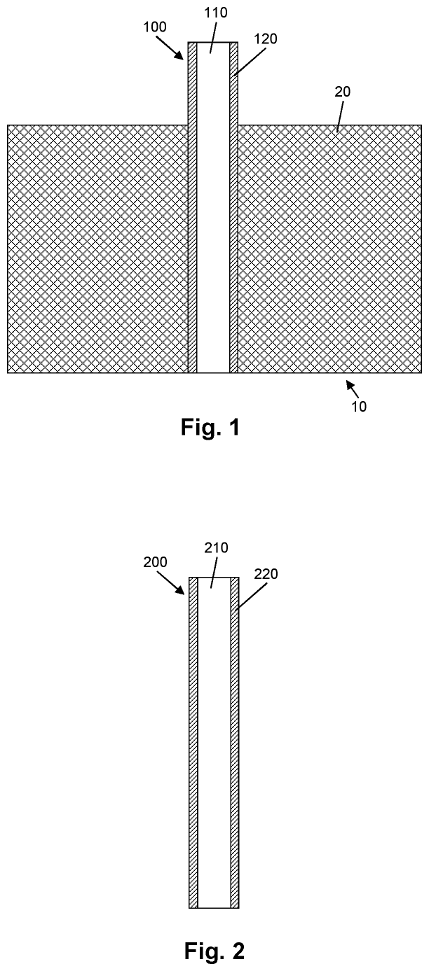

FIG. 2 schematically depicts a longitudinal cross section of a support 200 for an electrode according to an exemplary embodiment of the invention.

In detail, the support 200 is for a porous carbon electrode for electroanalysis. The support comprises an electrical conductor 210, wherein the electrical conductor 210 comprises a first metal, wherein the electrical conductor 210 has a coating layer 220 comprising carbon and wherein the coating layer 220 is arranged to, in use, electrically couple with the porous carbon electrode.

In this example, the electrical conductor 210 is a metal wire, having a diameter of 0.5 mm and a length larger than that of the porous carbon electrode. A cylindrical surface of the electrical conductor 210 is entirely coated by the coating layer 220. An exposed end of the electrical conductor 210 is uncoated (i.e. is not coated with the coating layer 220).

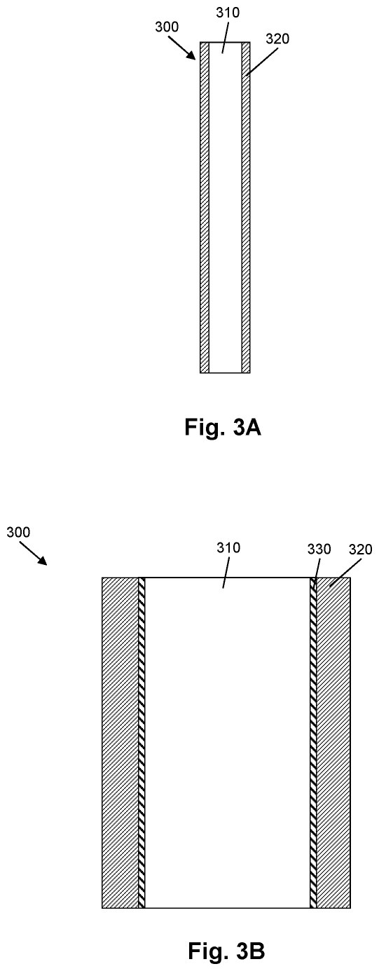

FIG. 3A schematically depicts a longitudinal cross section of another support 300 for an electrode according to an exemplary embodiment of the invention and FIG. 3B schematically depicts a longitudinal cross section of the support 300 of FIG. 3A in more detail.

In detail, the support 300 is for a porous carbon electrode for electroanalysis. The support comprises an electrical conductor 310, wherein the electrical conductor 310 comprises a first metal, wherein the electrical conductor 310 has a coating layer 320 comprising carbon and wherein the coating layer 320 is arranged to, in use, electrically couple with the porous carbon electrode.

The support 300 comprises a first interlayer 330 arranged between the electrical conductor 310 and the coating layer 320. The first interlayer 330 is adjacent to the electrical conductor 310. The first interlayer 330 comprises a second metal.

In this example, the electrical conductor 310 is a metal wire, having a diameter of 0.5 mm and a length larger than that of the porous carbon electrode. A cylindrical surface of the electrical conductor 310 is entirely coated by the first interlayer 330 and the coating layer 320. An exposed end of the electrical conductor 310 is uncoated (i.e. is not coated with the coating layer 320).

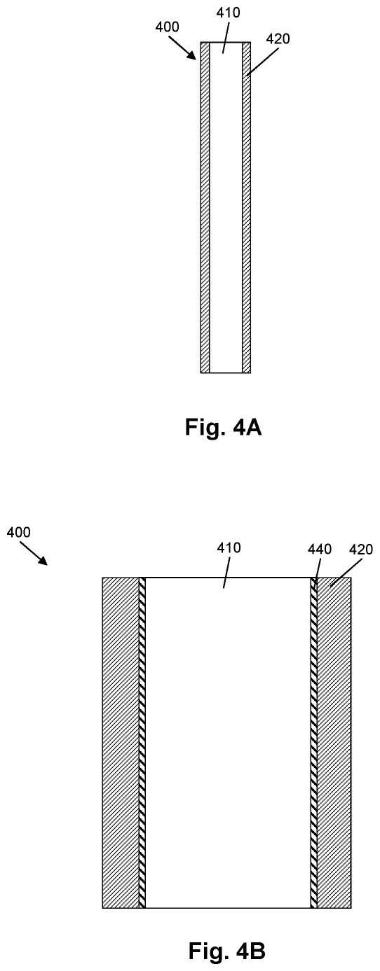

FIG. 4A schematically depicts a longitudinal cross section of yet another support 400 for an electrode according to an exemplary embodiment of the invention and FIG. 4B schematically depicts a longitudinal cross section of the support 400 of FIG. 4A in more detail.

In detail, the support 400 is for a porous carbon electrode for electroanalysis. The support comprises an electrical conductor 410, wherein the electrical conductor 410 comprises a first metal, wherein the electrical conductor 410 has a coating layer 420 comprising carbon and wherein the coating layer 420 is arranged to, in use, electrically couple with the porous carbon electrode.

The support 400 comprises a second interlayer 440 arranged between the electrical conductor 410 and the coating layer 420. The second interlayer 440 is adjacent to the coating layer 420. The second interlayer 440 comprises carbon and a third metal.

In this example, the support 400 does not comprise a first interlayer, such as the first interlayer 330 described with reference to FIGS. 3A and 3B, for example.

In this example, the electrical conductor 410 is a metal wire, having a diameter of 0.5 mm and a length larger than that of the porous carbon electrode. A cylindrical surface of the electrical conductor 410 is entirely coated by the second interlayer 440 and the coating layer 420. An exposed end of the electrical conductor 410 is uncoated (i.e. is not coated with the coating layer 420).

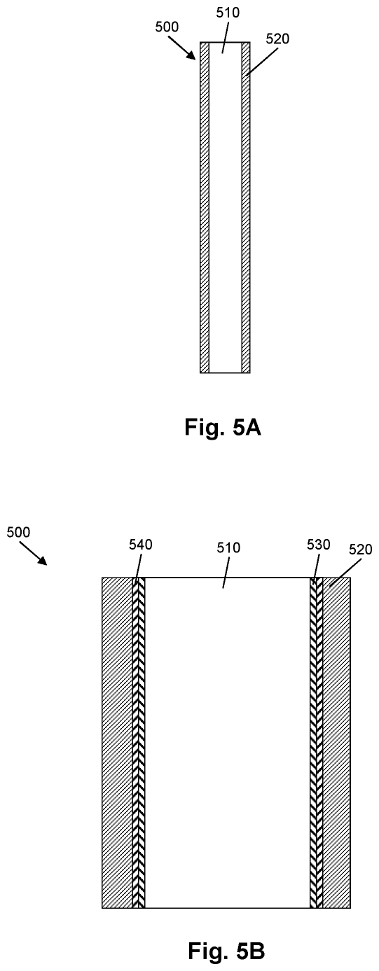

FIG. 5A schematically depicts a longitudinal cross section of still yet another support 500 for an electrode according to an exemplary embodiment of the invention and FIG. 5B schematically depicts a longitudinal cross section of the support 500 of FIG. 5A in more detail.

In detail, the support 500 is for a porous carbon electrode for electroanalysis. The support comprises an electrical conductor 510, wherein the electrical conductor 510 comprises a first metal, wherein the electrical conductor 510 has a coating layer 520 comprising carbon and wherein the coating layer 520 is arranged to, in use, electrically couple with the porous carbon electrode.

The support 500 comprises a first interlayer 530 arranged between the electrical conductor 510 and the coating layer 520. The first interlayer 530 is adjacent to the electrical conductor 510 and the first interlayer 530 comprises a second metal.

The support 500 comprises a second interlayer 540 arranged between the electrical conductor 510 and the coating layer 520. The second interlayer 540 is adjacent to the coating layer 520. The second interlayer 540 comprises carbon and a third metal.

In this example, the electrical conductor 510 is a metal wire, having a diameter of 0.5 mm and a length larger than that of the porous carbon electrode. A cylindrical surface of the electrical conductor 510 is entirely coated by the first interlayer 530, the second interlayer 540 and the coating layer 520. An exposed end of the electrical conductor 510 is uncoated (i.e. is not coated with the coating layer 520).

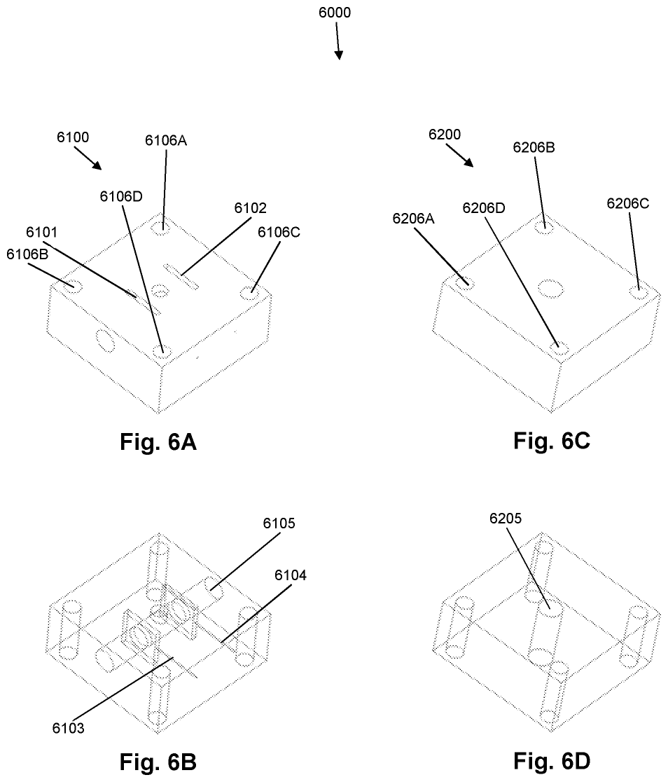

FIGS. 6A-6D schematically depict a flow cell 6000 according to an exemplary embodiment of the invention. The flow cell 6000 is designed for electroanalysis experiments using the standard 3-electrode configuration (working electrode, counter electrode and reference electrode).

The flow cell 6000 comprises a lower section or base 6100 and an upper section 6200. Particularly, FIG. 6A schematically depicts a perspective view of the lower section 6100, FIG. 6B schematically depicts a perspective view of the lower section 6100 showing internal features thereof (i.e. a transparent view, a hidden lines view), FIG. 6C schematically depicts a perspective view of the upper section 6200 and FIG. 6D schematically depicts a perspective view of the upper section 6200 showing internal features thereof (i.e. a transparent view, a hidden lines view).

The lower section 6100 (FIGS. 6A and 6B) comprises two square chambers 6101, 6102 for the insertion of graphite felt electrodes, each with a narrow conduit 6103, 6104 to allow a connecting wire (i.e. a support) to be pushed in. The upstream GF electrode is the working electrode and the connecting wire (or support) is a metal wire or a carbon coated metal wire (the latter being preferred). The downstream GF electrode is the counter electrode for which the connecting wire can be a carbon coated metal wire or a metal wire (e.g. platinum). A central flow channel 6105 allows the solution to flow through both electrodes. A central hole 6205 running through the top section 6200 (FIGS. 6C and 6D) into the flow channel 6105 in the lower section 6100 allows the reference electrode access to the system. On assembly, a gasket (not shown) is placed between the two sections 6100, 6200 to prevent leakage. The additional four holes 6106A-6106D and 6206A-6206D in the corners of the upper section 6100 and the lower section 6200 respectively allow the two sections 6100, 6200 to be bolted together.

### EXAMPLE 1

### Production of Carbon Coated Stainless Steel Wire

Stainless steel wires (i.e. electrical conductors comprising a first metal) of 0.5 mm diameter (grade 304, purchased from Alfa Aesar, UK) were coated in a graphitic-like material to produce carbon coated stainless steel wires (i.e. supports) for connection to graphite felt electrodes (i.e. non-woven carbon fibre electrodes). Carbon coating was carried out by Teer Coatings Ltd (Droitwich, UK) and involved a variation of their commercial product Graphit-iC™ [Tribology International, 37, 2004, 949]. The coating was deposited by closed field unbalanced magnetron sputter ion plating [UK Patent No. GB2258343B] from carbon and titanium targets using unbalanced magnetrons in a closed field arrangement. A titanium interlayer (i.e. a first interlayer) of approximately 0.1 microns was initially deposited on the wire surface to ensure sufficient adhesion of the carbon to the stainless steel. This was followed by a titanium-carbon ramp layer (i.e. a second interlayer comprising carbon and a third metal) of approximately 0.2 microns. Finally, a pure carbon layer (i.e. a coating layer) was deposited with a thickness of approximately 1 micron, such that the total coating thickness was 1-1.5 microns.

Before a coating run, the stainless steel wire was cleaned with acetone and ultrapure water (18.2 MΩ cm, Milli-Q®). The clean wire was positioned in a bespoke jig, essentially held between two clamping points, and then placed in the sputter chamber. The jig-clamping arrangement allowed for a uniform coating over most the wire's surface.

### EXAMPLE 2

### Comparison of Different Graphite Felt Connection Methods for the Detection of Lead

All chemicals (analytical grade) were used as received from VWR without further purification. Solutions of lead nitrate in 0.1 M NaBF₄ were prepared using ultrapure water (18.2 MΩ cm, Milli-Q®). The solutions were purged using nitrogen gas whilst stirring for 15 minutes. The carbon coated stainless steel wire was the same as that described in Example 1. Other wires used to evaluate the effect of the connection to the graphite felt electrode were titanium (0.25 mm diameter, 99.99% purity, Alfa Aesar), silver (0.5 mm diameter, 99.9% purity, Alfa Aesar) stainless steel (grade 304, 0.51 mm diameter, Alfa Aesar), platinum (0.5 mm diameter, 99.95% purity, Alfa Aesar), gold (0.25 mm diameter, 99.95% purity, Alfa Aesar), copper (0.5 mm diameter, 99.9999% purity, Alfa Aesar) and a glassy carbon rod (1 mm diameter, type 1, Alfa Aesar).

Voltammetric measurements were carried out using a μAutolab III (ECO-Chemie, Utrect, The Netherlands) potentiostat. All measurements were conducted using a three-electrode cell. The counter electrode was a piece of graphite felt (GF), prepared as described for the working electrode below, attached to a platinum wire. The reference was a saturated silver-silver chloride (Ag/AgCl) electrode (IJ Cambria Scientific Ltd, UK). Three 3 mm diameter carbon disc electrodes (i.e. porous carbon electrodes), edge plane pyrolytic graphite (EPPG), basal plane pyrolytic graphite (BPPG) and pyrolytic formed carbon (PFC), were also used as working electrodes (all three purchased from IJ Cambria Scientific Ltd, UK) for means of comparison with GF electrodes (EPPG, BPPG and PFC disc electrodes are commonly used working electrodes in electroanalysis). The EPPG and PFC electrodes were prepared by polishing with diamond slurries of decreasing particle size (6 μm, 3 μm and 1 μm) on a cloth lapping pad followed by washing the surface in ultrapure water and briefly sonicating. The BPPG electrode was prepared by using adhesive tape to exfoliate the surface, presenting a fresh basal surface. The electrode was then washed with ethanol to remove any adhesive residue and then briefly sonicated in ultrapure water. The GF used was GFD 2.5, a commercially available felt supplied by SGL Group, with a nominal thickness of 2.8 mm (measured under a slight compressive force). A 1×1 cm (i.e. 1 cm²) piece of GF was cut from a clean roll of the felt using a bespoke ‘cookie cutter’ tool then weighed using a 4-point balance to allow a surface area of the felt to be estimated, following previously described methods [Journal of Electroanalytical Chemistry, 747, 2015, 29]. The felt was secured and electrically connected to the potentiostat by forcing a wire (or carbon rod) through it. The GF electrode was initially washed in ethanol then rinsed with ultrapure water via a wash-bottle. The water-wet GF electrode was then sonicated for 1 minute in a sacrificial sample of the test electrolyte before being transferred to the quiescent electrochemical cell (a beaker containing the test solution and electrodes).

Anodic stripping voltammetry (ASV) was performed with the four working electrode materials (EPPG, BPPG, PFC and GF) in solutions containing trace amounts of Pb²⁺, following a method similar to that used previously [Journal of Electroanalytical Chemistry, 638, 2010, 9]. This involved an initial preconditioning of the electrode surface at 0.2 V (vs. Ag/AgCl) for 30 s, followed by Pb deposition (always under quiescent conditions) at −0.7 V (vs. Ag/AgCl) for 60 s. Pb deposits were then removed via electrochemical oxidation (stripping) by linear sweep voltammetry (−0.7 V to −0.3 V vs. Ag/AgCl at 0.05 V s⁻¹), resulting in a Pb stripping peak (where observable). All experiments were conducted at 20±1° C. Given the relatively large currents obtained with GF electrodes for trace analysis (tens of μA) and the scan rate used in this work (0.05 V s⁻¹), a Faraday cage was not required, demonstrating an advantage of GF electrodes.

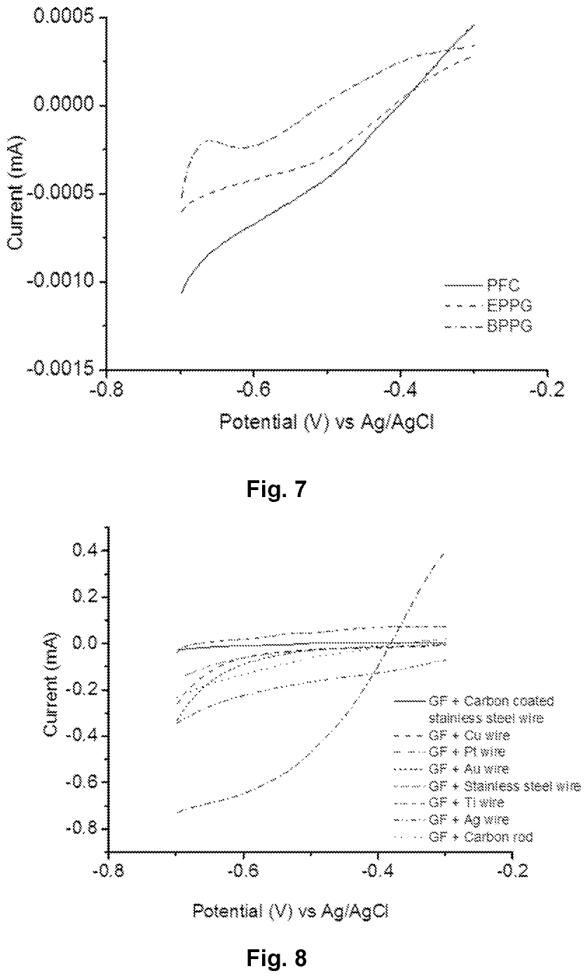

FIG. 7 schematically depicts results of anodic stripping voltammetry obtained with EPPG, BPPG and PFC disc electrodes (3 mm diameter) in 0.25 μM Pb(NO₃)₂/0.1 M NaBF4 at 50 mV s⁻¹.

Particularly, FIG. 7 illustrates anodic stripping voltammograms conducted in 0.25 μM Pb(NO₃)₂ and 0.1 M NaBF₄ solution (scan rate of 50 mV s⁻¹) obtained with the three 3 mm disc electrodes (EPPG, BPPG and PFC). For all three voltammograms, the baseline (background current) dominates the plot and no obvious Pb stripping signal is observed. FIG. 8 illustrates anodic stripping voltammograms conducted under the same conditions as in FIG. 7, where the working electrode is a graphite felt electrode connected via a range of different wires.

FIG. 8 schematically depicts results of anodic stripping voltammetry obtained with GF-carbon coated stainless steel wire, GF-carbon rod and GF-metal wire electrodes in 0.25 μM Pb(NO₃)₂/0.1 M NaBF₄ at 50 mV s⁻¹.

The magnitude of the recorded currents is much larger for the graphite felts than the carbon disc electrodes due to their high surface area. With the exception of the carbon coated wire, titanium wire and platinum wire connections, all the voltammograms have a baseline of similar shape and magnitude, with no observable Pb stripping peak. The baseline for the Pt-wire connected GF electrode is even larger, further decreasing the possibility of resolving a Pb stripping peak. In contrast, the baseline for the graphite felt with carbon coated wire and titanium wire connections is considerably flatter and less intense than the other electrodes, with a peak observable around ˜−0.5 V vs. Ag/AgCl, in agreement with previous studies on trace lead detection via anodic stripping voltammetry [Sensors and Actuators B: Chemical, 204, 2014, 136; Electrochimica Acta, 115, 2014, 471].

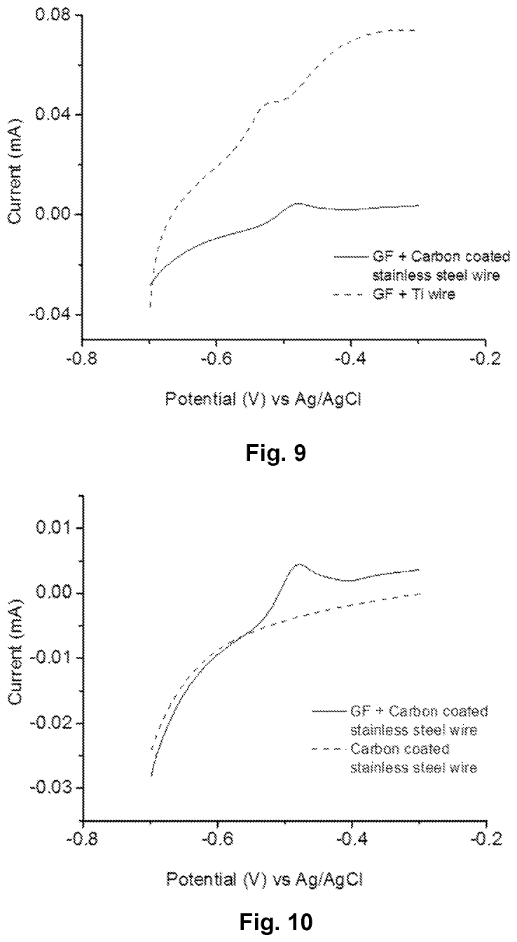

FIG. 9 schematically depicts results of anodic stripping voltammetry obtained with GF-carbon coated stainless steel wire and GF-titanium wire electrodes in 0.25 μM Pb(NO₃)₂/0.1 M NaBF₄ at 50 mV s⁻¹.

Particularly, FIG. 9 illustrates a magnified plot of both the GF-carbon coated wire electrode and GF-titanium wire electrode from FIG. 8. Although a Pb stripping peak is observable with the Ti wire-GF electrode (around 0.5 V vs Ag/AgCl), the baseline is much steeper than that for the carbon coated stainless steel wire-GF electrode. Consequently, the Pb stripping peak for the latter electrode is considerably better defined, easier to analyse and, therefore, more favourable for trace Pb detection.

FIG. 10 schematically depicts results of anodic stripping voltammetry obtained with a GF-carbon coated stainless steel wire electrode and a carbon coated stainless steel wire in 0.25 μM Pb(NO₃)₂/0.1 M NaBF₄ at 50 mV s⁻¹.

Particularly, FIG. 10 illustrates the same linear sweep voltammogram for the carbon coated stainless steel wire-GF electrode in FIG. 9 compared with the corresponding signal obtained with only the carbon coated stainless steel wire (i.e. no GF). When the carbon coated stainless steel wire was used without a graphite felt electrode (i.e. wire only) under the same experimental conditions, no Pb stripping signal was observed.

Graphite felt electrodes have been shown to be superior to carbon disc electrodes for the detection of trace metals [Analyst, 141, 2016, 4742]. Particularly, the signal in FIG. 9 (graphite felt electrode) is improved compared with those in FIG. 7 (carbon disc electrodes). However, the method of connection to a graphite felt electrode has not previously been studied in such detail as in FIG. 8. Surprisingly, the nature of the connection has a noticeable impact on the stripping signal. From FIG. 8, the carbon coated stainless steel wire significantly reduces the background signal compared to the other connection methods. This results in a Pb stripping signal that can be clearly identified above the baseline.

### EXAMPLE 3

### Using the GF-Carbon Coated Stainless Steel Wire Electrode for the Detection of Lead

Using the carbon coated stainless steel wire from Example 1 in combination with a 1×1 cm (i.e. 1 cm²) section of graphite felt, anodic stripping voltammetry experiments were performed with solutions containing a range of Pb concentrations (10 nM to 630 nM) to determine the limit of detection and linear range of the sensor. The chemicals, equipment and procedure used in this example were identical to those used in Example 2 with the following amendment; following the Pb deposition step, the stripping potential was swept from −0.7 V to −0.1 V vs. Ag/AgCl. A fresh piece of felt was prepared as described in the previous example for each of the 10 solutions tested (10 nM, 16 nM, 25 nM, 40 nM, 63 nM, 160 nM, 250 nM, 320 nM, 400 nM and 630 nM), with the solutions used from lowest concentration to highest to further prevent contamination of equipment. Each solution was degassed under N₂ also as described previously. Details relating to the peak, such as integrated area, peak height and peak potential, were obtained using the Peak Analyser function found in the data analysis and graphics software, OriginPro 9 (Version 92E, OriginLab, USA). This allowed for simultaneous baseline correction of the forward voltammetric scan and the integration of the area under the peaks found in said scan.

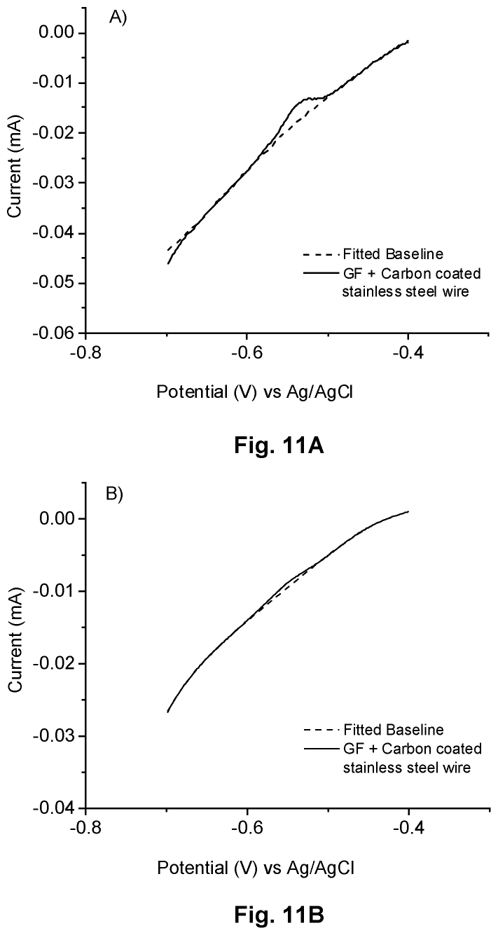

FIGS. 11A and 11B schematically depict results of anodic stripping voltammetry obtained with GF-carbon coated stainless steel wire electrode in 0.16 μM Pb(NO₃)₂/0.1 M NaBF₄ and 25 nM Pb(NO₃)₂/0.1 M NaBF₄ at 50 mV s⁻¹, respectively. In both plots, the fitted baseline is overlaid;

Particularly, FIGS. 11A and 11B show the experimental data for the 160 nM and 25 nM Pb(NO₃)₂ solutions, plotted alongside the fitted baselines obtained through the OriginPro 9 software. Using this technique, it is easy to distinguish the Pb stripping peak and determine the derived data relating to the peak properties. The results for the different Pb concentrations are given in Table 1, where peak area, peak potential and peak height refer to the baseline-corrected signals. It was not possible to determine a peak below 25 nM so there are no results for the 10 nM and 16 nM solutions.

TABLE 1
Results (baseline corrected) of stripping peak
analysis for 25-630 nM Pb(II) concentrations.

| Concentration | Peak Area | Peak | Peak |
|---|---|---|---|
| (nM) | (A V⁻¹) | Potential (V) | Height (A) |
| 25 | 3.44 × 10⁻⁸ | −0.55 | 6.90 × 10⁻⁷ |
| 40 | 4.33 × 10⁻⁸ | −0.56 | 9.41 × 10⁻⁷ |
| 63 | 1.90 × 10⁻⁸ | −0.55 | 3.02 × 10⁻⁷ |
| 100 | 9.42 × 10⁻⁸ | −0.54 | 1.92 × 10⁻⁶ |
| 160 | 1.65 × 10⁻⁷ | −0.53 | 3.62 × 10⁻⁶ |
| 250 | 4.32 × 10⁻⁷ | −0.52 | 1.01 × 10⁻⁵ |
| 320 | 6.18 × 10⁻⁷ | −0.52 | 1.38 × 10⁻⁵ |
| 400 | 7.45 × 10⁻⁷ | −0.51 | 1.70 × 10⁻⁵ |
| 630 | 1.18 × 10⁻⁶ | −0.51 | 2.43 × 10⁻⁵ |

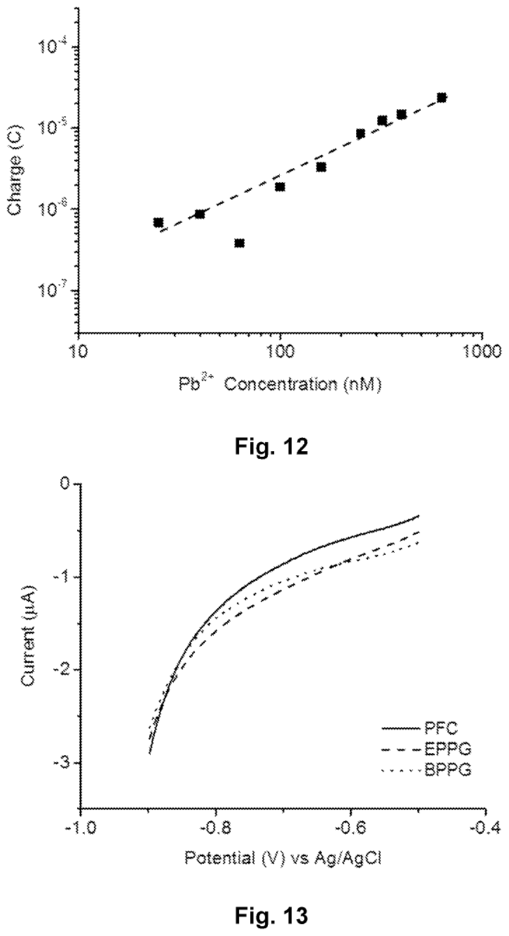

The amount of Pb deposited on the electrode surface is directly proportional to the charge passed during the stripping event (assuming all the Pb is electrochemically removed from the electrode surface), which is equal to the integral of the stripping peak divided by the scan rate. The stripping charge is plotted against Pb²⁺ concentration in FIG. 12, as described below.

FIG. 12 schematically depicts results of anodic stripping voltammetry showing a plot of stripping charge versus Pb²⁺ concentration with GF-carbon coated stainless steel wire electrodes in solutions of increasing concentrations of Pb(NO₃)₂.

The results form a straight line (except for one outlier) demonstrating a large linear range for Pb(II) detection with a GF-carbon coated stainless steel wire electrode. Below 25 nM it was not possible to determine a stripping peak, suggesting the limit of detection for this sensor in quiescent solutions is around 25 nM. Related experiments using this technique have not found an upper limit for this linear range despite measuring samples several orders of magnitude higher in concentration than shown here, which is another valuable aspect of the invention.

### EXAMPLE 4

### Comparison of Different Graphite Felt Connection Methods for the Detection of Cadmium

The experimental method used here is the same as that of Example 2, with the following exceptions: solutions of cadmium sulphate (Analytical grade, VWR) in 0.1 M NaBF₄ were prepared using ultrapure water (18.2 MΩ cm, Milli-Q®). The solutions were purged using nitrogen gas whilst stirring for 15 minutes. The carbon coated stainless steel wire was the same as that described in Example 1. Cd deposition (always under quiescent conditions) was performed at −1.1 V (vs. Ag/AgCl) for 60 s. The Cd deposits were then removed via electrochemical oxidation (stripping) by linear sweep voltammetry (−0.9 V to −0.5 V vs. Ag/AgCl at 0.05 V s⁻¹). All experiments were conducted at 20±1° C.

FIG. 13 schematically depicts results of anodic stripping voltammetry obtained with EPPG, BPPG and PFC disc electrodes (3 mm diameter) in 0.5 μM CdSO₄/0.1 M NaBF₄ at 50 mV s⁻¹.

Particularly, FIG. 13 illustrates anodic stripping voltammograms conducted in 0.5 μM CdSO₄/0.1 M NaBF₄ aqueous solution (scan rate of 50 mV s⁻¹) obtained with the three 3 mm disc electrodes (EPPG, BPPG and PFC). In an analogous situation to Example 2, the baseline (background current) for all 3 voltammograms dominates the plot and no obvious Cd stripping signal is observed.

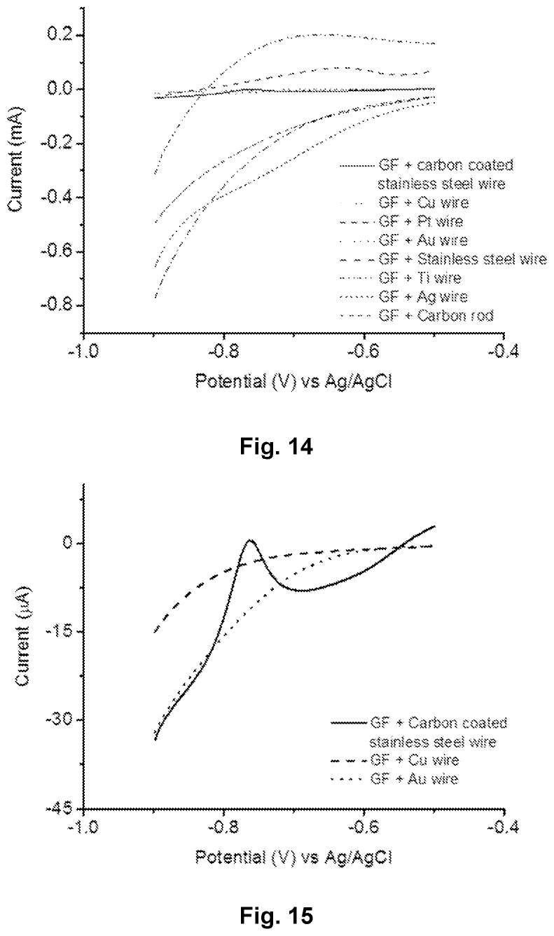

FIG. 14 schematically depicts results of anodic stripping voltammetry obtained with GF-carbon coated stainless steel wire, GF-carbon rod and GF-metal wire electrodes in 0.5 μM CdSO₄/0.1 M NaBF₄ at 50 mV s⁻¹.

Particularly, FIG. 14 illustrates anodic stripping voltammograms conducted under the same conditions as in FIG. 13, where the working electrode is graphite felt connected via a range of different wires (and a glassy carbon rod).

Again, the magnitude of the recorded currents is much larger for the graphite felts than the three carbon disc electrodes due to their high surface area. Apart from the carbon coated wire, copper wire and gold wire, most voltammograms have a baseline of similar shape and magnitude, with no observable Cd stripping peak. The voltammograms for the gold and copper connections display a much flatter baseline, but an observable Cd stripping peak is still absent. The baseline for the graphite felt with a carbon coated stainless steel wire connection is of similar shape and size to that for the gold and copper wire connections, but in this case a Cd stripping peak is observable at around −0.75 V vs. Ag/AgCl.

FIG. 15 schematically depicts results of anodic stripping voltammetry obtained with GF-carbon coated stainless steel wire, GF-gold wire and GF-copper wire electrodes in 0.5 μM CdSO₄/0.1 M NaBF₄ at 50 mV s⁻¹.

Particularly, FIG. 15 illustrates a magnified plot of the GF-carbon coated stainless steel wire, GF-gold wire and GF-copper wire electrode voltammograms from FIG. 14, confirming the absence of a stripping peak for the copper and gold wire connections. In contrast, a clear stripping signal is observed with the GF-carbon coated stainless steel wire electrode. The peak is centred around −0.77 V vs Ag/AgCl, which agrees with previous studies of Cd stripping voltammetry. Thus, it appears only the carbon coated wire connection to the graphite felt electrode resulted in an observable Cd stripping signal from all the electrodes tested. Note, when the carbon coated stainless steel wire was used without a graphite felt electrode (i.e. wire only) under the same experimental conditions, no Cd stripping signal was observed.

### EXAMPLE 5

### Using the GF-Carbon Coated Stainless Steel Wire Electrode for the Detection of Cadmium

Using the carbon coated stainless steel wire from Example 1 in combination with a 1×1 cm (i.e. 1 cm²) section of graphite felt, anodic stripping voltammetry experiments were performed with solutions containing a range of Cd²⁺ concentrations (10 nM to 320 nM) to determine the limit of detection and linear range of the sensor. The chemicals, equipment and procedure used in this example were identical to those used in Example 2 with the following amendments; the electrodeposition of Cd on the electrode surface was performed at −1.1 V (vs. Ag/AgCl) for 60 s followed by a linear potential sweep from −0.9 V to −0.5 V vs. Ag/AgCl to produce a stripping signal. A fresh piece of felt was prepared as described in the previous example for each of the 9 solutions (10 nM, 16 nM, 25 nM, 32 nM, 40 nM, 63 nM, 160 nM, 250 nM and 320 nM), with the solutions used from lowest concentration to highest to further prevent contamination of equipment. The solutions were degassed using N₂ as previously described. OriginPro 9 was used for the analysis of results as described in Example 3.

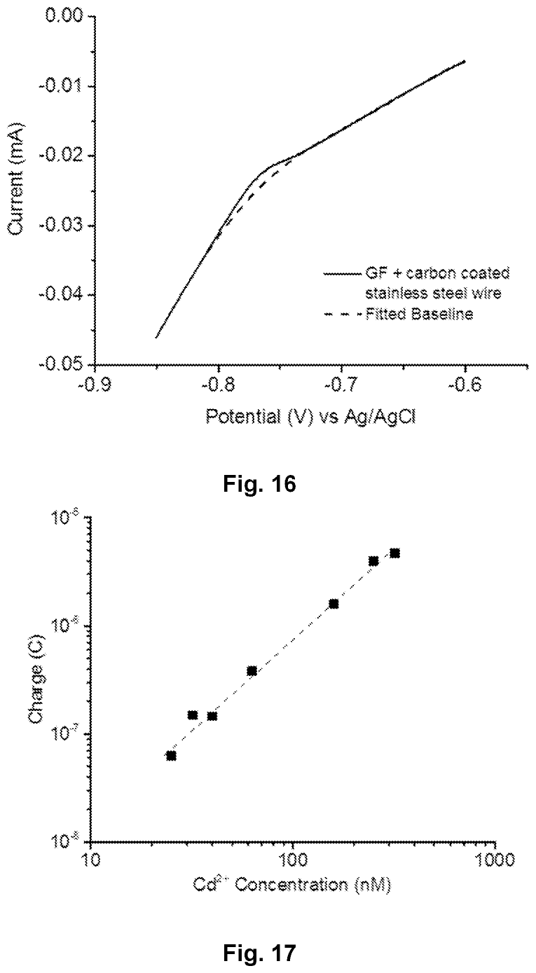

FIG. 16 schematically depicts results of anodic stripping voltammetry GF-carbon coated stainless steel wire electrode in 0.16 μM CdSO₄/0.1 M NaBF₄ at 50 mV s⁻¹. The fitted baseline is overlaid.

Particularly, FIG. 16 shows the experimental anodic stripping voltammogram for the 160 nM CdSO₄ solution (obtained with the GF-carbon coated stainless steel wire electrode), plotted alongside the fitted baselines obtained through the OriginPro 9 software. Using this technique, it is easy to distinguish the Cd stripping peak and determine the derived data relating to the peak properties. The results for the ASV peak analysis for the full range of Cd²⁺ concentrations are given in Table 2. As with the detection of Pb²⁺ in Example 3, it was not possible to determine a Cd²⁺ stripping peak for either the 10 nM or 16 nM solutions.

TABLE 2
Results (baseline corrected) of stripping peak
analysis for 25-320 nM Cd(II) concentrations.

| Concentration | Peak Area | Peak | Peak |
|---|---|---|---|
| (nM) | (A V⁻¹) | Potential (V) | Height (A) |
| 25 | 3.16 × 10⁻⁹ | −0.76 | 1.27 × 10⁻⁷ |
| 32 | 7.46 × 10⁻⁹ | −0.78 | 2.21 × 10⁻⁷ |
| 40 | 7.29 × 10⁻⁹ | −0.76 | 2.40 × 10⁻⁷ |
| 63 | 1.90 × 10⁻⁸ | −0.76 | 5.06 × 10⁻⁷ |
| 160 | 7.97 × 10⁻⁸ | −0.76 | 1.87 × 10⁻⁶ |
| 250 | 1.98 × 10⁻⁷ | −0.74 | 4.51 × 10⁻⁶ |
| 320 | 2.33 × 10⁻⁷ | −0.75 | 5.57 × 10⁻⁶ |

The amount of Cd deposited on the electrode surface is directly proportional to the charge passed during the stripping event (assuming all the Cd is removed from the electrode surface), which is equal to the integral of the stripping peak divided by the scan rate. The stripping charge is plotted against Cd²⁺ concentration in FIG. 17, as detailed below.

FIG. 17 schematically depicts results of anodic stripping voltammetry showing a plot of stripping charge versus Cd²⁺ concentration for ASV experiments with GF-carbon coated stainless steel wire electrodes in solutions increasing concentrations of CdSO₄.

Particularly, the results of FIG. 17 form a straight line demonstrating a large linear range for Cd²⁺ detection with a GF-carbon coated stainless steel wire electrode. Below 25 nM it was not possible to determine a stripping peak, suggesting the limit of detection for this sensor in quiescent solutions is around 25 nM. Related experiments using this technique have not found an upper limit for this linear range despite measuring samples several orders of magnitude higher in concentration than shown here, which is another valuable aspect of the invention.

### EXAMPLE 6

### Comparison of Wires for the Detection of Cadmium in a Flow Cell System

All chemicals (analytical grade) were used as received from VWR, with the exception of the cadmium sulphate octahydrate (Alfa Aesar, 98-102%), without further purification. A solution of cadmium sulphate in 0.1 M NaBF₄ was prepared using ultrapure water (18.2 MΩ cm, Milli-Q®).

The solution was purged using nitrogen gas whilst being circulated through the flow cell system for at least 30 minutes before measurements were taken. The carbon coated stainless steel wire was the same as that described in Example 1. A platinum wire (0.5 mm diameter, 99.95% purity, Alfa Aesar), was also used to evaluate the connection to the graphite felt. Voltammetric measurements were carried out using a SP-300 potentiostat (Bio-logic SAS, France). All measurements were conducted using a custom designed, three-electrode flow cell shown in FIGS. 6A-6D, with the flow controlled by a peristaltic pump (Masterflex, UK). The reference was a saturated silver-silver chloride (Ag/AgCl) electrode (Innovative Instruments, Inc, USA). The graphite felt used as both the working and counter electrode material was GFD 2.5, a commercially available felt supplied by SGL Group, with a nominal thickness of 2.8 mm (measured under a slight compressive force). Two 2×2 cm pieces of graphite felt (GF) were cut from a clean roll of the felt using a bespoke ‘cookie cutter’ tool and placed into the flow cell without further preparation. The counter electrode graphite felt was connected by pushing a platinum wire through it, the working electrode graphite felt was connected by pushing either a platinum or a carbon coated stainless steel wire though it.

Anodic stripping voltammetry (ASV) was performed with the working electrode graphite felt attached using both a carbon coated stainless steel wire and a platinum wire support, in solutions containing trace amounts of Cd²⁺. Cd deposition was performed at −1.4 V (vs. Ag/AgCl) for 300 s whilst flowing the solution though the cell at 150 ml min⁻¹. Cd deposits were then removed via electrochemical oxidation (stripping) by linear sweep voltammetry (−0.85 V to −0.2 V at 0.05 V s⁻¹), resulting in a Cd stripping peak (where observable). All experiments were conducted at 20±1° C. Given the relatively large currents obtained with GF electrodes for trace analysis (hundreds of μA) and the scan rate used in this work (0.05 V s⁻¹), the magnitude of the currents was such that a Faraday cage was not required, demonstrating another advantage of the invention.

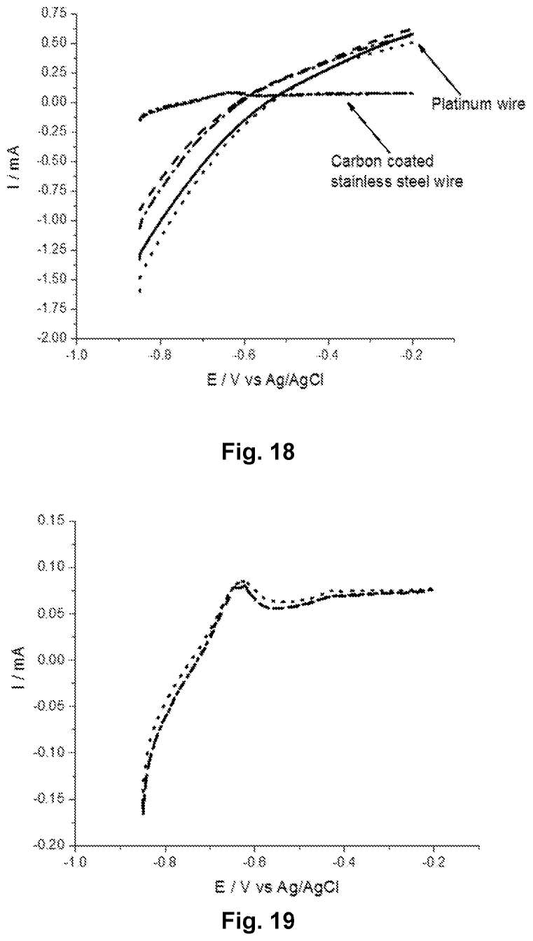

FIG. 18 schematically depicts results of anodic stripping voltammetry obtained with Pt and carbon coated stainless steel wire connections to a GF electrode in 0.5 μM CdSO₄/0.1 M NaBF₄ at 50 mV s⁻¹.

Particularly, FIG. 18 illustrates anodic stripping voltammograms conducted in 0.5 μM CdSO₄ and 0.1 M NaBF₄ solution (scan rate of 50 mV s⁻¹) for a GF connected by either a Pt or carbon coated stainless steel wire. For the voltammograms based on the Pt-GF connection, the baseline (background current) dominates the plot and no obvious Cd stripping signal is observed.

FIG. 19 schematically depicts results of anodic stripping voltammetry obtained with a carbon coated stainless steel wire connection to a GF electrode in 0.5 μM CdSO₄/0.1 M NaBF₄ at 50 mV s⁻¹.

Particularly, FIG. 19 illustrates anodic stripping voltammograms conducted under the same conditions as in FIG. 18; where the working electrode is graphite felt connected via carbon coated stainless steel wire, a clean stripping peak is observed at −0.65 V (vs Ag/AgCl).

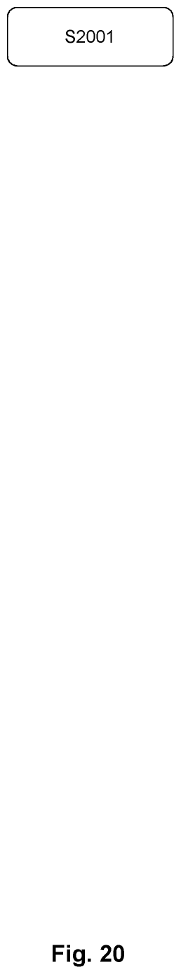

FIG. 20 schematically depicts a method of manufacturing a support for an electroanalysis porous carbon electrode according to an exemplary embodiment of the invention.

At S2001, an electrical conductor comprising a first metal is coated with a coating layer comprising carbon. The coating layer is arranged to, in use, electrically couple with the porous carbon electrode.

The method may include any of the steps described previously.

Although a preferred embodiment has been shown and described, it will be appreciated by those skilled in the art that various changes and modifications might be made without departing from the scope of the invention, as defined in the appended claims and as described above.

In summary, the invention provides an electrode assembly, a support for an electrode, a flow cell, a method manufacturing a support, use of an electrode assembly and use of a flow cell. Particularly, the support improves limits of detection of electroanalysis.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. An electrode assembly for electroanalysis, the electrode assembly comprising a support and a porous carbon electrode supported by the support, wherein the support comprises an electrical conductor comprising a first metal, wherein the electrical conductor has a coating layer comprising at least 90% carbon by weight of the coating layer, wherein the coating layer is provided over at least 90%, preferably at least 95%, more preferably at least 98% of a surface of the electrical conductor and wherein the coating layer is arranged to, in use, electrically couple with the porous carbon electrode.

2. The electrode assembly according to claim 1, wherein the first metal comprises titanium or a titanium alloy and/or a first alloy, for example a steel, preferably a stainless steel, more preferably wherein the electrical conductor consists of the stainless steel.

3. The electrode assembly according to claim 1, wherein the support comprises a first interlayer arranged between the electrical conductor and the coating layer.

4. The electrode assembly according to claim 3, wherein the first interlayer is adjacent to the electrical conductor and wherein the first interlayer comprises a second metal, preferably titanium or chromium, having a thickness in a range from 0.001 μm to 10 μm, preferably in a range from 0.01 μm to 1 μm.

5. The electrode assembly according to claim 3, wherein the support comprises a second interlayer arranged between the electrical conductor and the coating layer.

6. The electrode assembly according to claim 5, wherein the second interlayer is adjacent to the coating layer, wherein the second interlayer comprises carbon and a third metal, preferably titanium or chromium, and wherein a composition of the second interlayer is provided as a gradient composition.

7. The electrode assembly according to claim 1, wherein the porous carbon electrode is selected from a group comprising a glassy carbon foam, a carbon aerogels, a carbon powder and a woven or non-woven carbon fibre electrode, wherein the woven or non-woven carbon fibre electrode is selected from a group comprising: a graphite felt (GF) electrode, a woven carbon fibre cloth electrode, a non-woven carbon fibre cloth electrode, a carbon fibre veil electrode, a chopped carbon fibre electrode and a carbon fibre paper electrode.

8. The electrode assembly according to claim 7, wherein the support comprises a retaining member, arranged to retain the woven or non-woven carbon fibre electrode thereon.

9. The electrode assembly according to claim 1, wherein the support is provided as a wire and wherein the wire has a diameter in a range of from 0.1 to 1.0 mm, preferably in a range of from 0.25 to 0.75 mm, more preferably in a range of from 0.4 to 0.6 mm, for example 0.5 mm.

10. The electrode assembly according to claim 1, wherein the coating layer comprises a non-porous coating layer.

11. The electrode assembly according to claim 1, wherein the carbon comprising the coating layer is graphite, for example amorphous, partially crystalline, crystalline and/or microcrystalline graphite.

12. A flow cell comprising an electrode assembly according to claim 1.

13. A method of manufacturing a support for an electroanalysis porous carbon electrode, the method comprising:
coating an electrical conductor comprising a first metal with a coating layer comprising at least 90% carbon by weight of the coating layer, wherein the coating layer is provided over at least 90%, preferably at least 95%, more preferably at least 98% of a surface of the electrical conductor; and
wherein the coating layer is arranged to, in use, electrically couple with the porous carbon electrode.

14. The method according to claim 13, the method comprising providing a first interlayer on the electrical conductor by depositing, printing, spraying, plating and/or sputtering directly thereon and wherein the first interlayer comprises a second metal, preferably titanium or chromium, having a thickness in a range from 0.001 μm to 10 μm, preferably in a range from 0.01 μm to 1 μm.

15. The use of an electrical conductor comprising a first metal, wherein the electrical conductor has a coating layer comprising at least 90% carbon by weight of the coating layer, wherein the coating layer is provided over at least 90%, preferably at least 95%, more preferably at least 98% of a surface of the electrical conductor, as a support for a porous carbon electrode for electroanalysis of metal cations, wherein the coating layer is arranged to, in use, electrically couple with the porous carbon electrode.
